(19) United States
(12) Patent Application Publication
(10) Pub. No.: US 2014/0279249 A1
(43) Pub. Date: Sep. 18, 2014

(54) SYSTEMS AND METHODS FOR PROVIDING THIRD PARTY PRODUCT CROSS REFERENCING

(71) Applicant: W.W. GRAINGER, INC., Lake Forest, IL (US)

(72) Inventor: Geoffry A. Westphal, Evanston, IL (US)

(21) Appl. No.: 13/800,854

(22) Filed: Mar. 13, 2013

(51) Int. Cl. G06Q 30/06

(52) U.S. Cl. CPC G06Q 30/0625
USPC 705/26.62

(57) ABSTRACT

An third party cross-referencing functionality related to an item number directed to a product within an electronic catalog hosted by a vendor system is presented on a client computing device in a page providing an access point for searching an item. The system allows a customer to enter a vendor or non-vendor specific item number into a vendor system and have the provided number display a catalog page and/or item information related to the item number to the user whether the displayed data is vendor information or non-vendor information alike.

### CROSS REFERENCE TO RELATED APPLICATION

This application is related to U.S. patent application Ser. No. 13/693,676 entitled “Systems and Methods for Providing Automated Customer Order Cross Referencing,” filed on Dec. 4, 2012, the contents of which are incorporated herein by reference in their entirety.

### FIELD OF THE DISCLOSURE

The present description relates generally to third party ecommerce product identification and more particularly to systems and methods for providing third party product cross referencing.

### BACKGROUND OF RELATED ART

Currently, commerce suppliers and/or e-commerce related websites, whether business to business (B2B) or business to consumer (B2C), provide methods for a customer to navigate inventory. In particular, it is quite common for a large supplier or vendor, selling items from many different manufacturers and/or distributors, to provide a unique vendor item number (e.g., a catalog number, ordering number, inventory number, StockKeeping Unit (SKU), etc.) that corresponds to an item in the vendor's inventory system, and not necessarily to the manufacturer's or secondary item number.

Still further, while most businesses would like their customers to single source all of their purchases from that specific business, it is often realty that customers may not be one hundred percent loyal to a specific vendor, and may comparison shop with another and/or multiple competitors. As such, businesses may be wise to invest in knowledge of competitor product offerings and embrace comparison shopping to provide customer service that can tend to lead a customer to single source their purchases with the business.

Various forms of comparison shopping on ecommerce websites have been utilized in the past. Some webpages provide comparison shopping by searching a number of websites and/or databases for pricing information and providing the results in reviewable user interface, such as a list and/or grid. Most price comparison services do not sell products themselves, but source prices from retailers from whom users can buy. Additionally, price comparison sites typically do not charge users anything to use the site, but instead, they are monetized through payments from retailers who are listed on the site.

In other examples, a product website may provide highlighted comparisons of products with known competitors, for illustrating the superiority of their product. For example, a car manufacturer typically provides a feature comparison to similar models of competing automobiles, oftentimes highlighting portions of the specification wherein the car manufacturer's model is superior to the competitor model. These results, however, typically do not provide an objective view of the competitor's products, nor do they provide a view into the “context” of the product itself to help identify and/or suggest replacement products from the current manufacture's inventory.

As such, while the background systems and methods identified herein, generally work for their intended purpose, the subject invention provides improvements thereto, particularly providing systems and methods for allowing a customer and/or customer service representatives to cross-reference between one manufacturer's product with a similar one from the providing manufacturer/seller, to allow the searcher to review the products in context and make an informed comparison to drive further sales to the providing commerce provider.

### BRIEF DESCRIPTION OF THE DRAWINGS

For a better understanding of the present disclosure, reference may be had to various examples shown in the attached drawings.

FIG. 1 illustrates in block diagram form components of an example, computer network environment suitable for implementing example searching and cross referencing systems and methods disclosed.

FIG. 2 illustrates an example page that provide an access point in which a customer can enter a manufacturer, a competitor, or other non-vendor specific ordering number into an ordering system to display a competitor's page containing the searched item.

FIG. 3 illustrates an example page showing selection of one of the example competitor's pages containing the searched item as shown in FIG. 2.

FIG. 4 illustrates an example page similar to FIG. 2 showing selection of one of the example competitor products containing the search item.

### DETAILED DESCRIPTION

The following description of example methods and apparatus is not intended to limit the scope of the description to the precise form or forms detailed herein. Instead the following description is intended to be illustrative so that others may follow its teachings.

The present disclosure relates generally to product and/or keyword searching, and more particularly to an ecommerce website providing cross reference between one manufacturer's products with similar ones from another manufacturer. Additionally, the present disclosure provides for cross referencing between the catalog ordering numbers of two competitors, and cross reference functionality on websites to provide search results that make it easier for the source vendor to provide customer service and/or context to the search results so that the customer can order the same and/or related product from the source vendor. As such a better customer experience is likely achievable by using the electronic catalog version of the competitor's and manufacturer's that are part of the given cross reference search; customer often have or are referencing a competitor's catalog.

Specifically, in at least one example, when a customer (generically identified as a “user”, “consumer”, “purchaser”, etc.) inputs any item number, model number, etc. matching logic finds exact and functional equivalent items in other vendor's paper or electronic catalogs by using a database on the provider's server(s) and/or through dynamic linking and/or searching with the relevant competitor's webpages. The corresponding catalog page(s) for each vendor are displayed, providing context to the search results. For instance, a business must appreciate that their customers may search and/or buy from competitors and as such, it is helpful to know for a prudent business to know what the customer is looking and/or searching for.

By providing a searching customer the ability to cross reference competitor ordering numbers, and provide search results and/or alternatives in context with the search terms, customers and employees of the supplier alike can be better informed and thus better able to make the correct choice for product ordering, which is hoped to be from the source vendor. Still further, by providing direct access to viewable competitor items, such as for example, catalog pages, the customer can reference the competitor's website to provide context in comparing the current offerings of the supplier website.

Entering a competitor's ordering number (e.g., SKU number, manufacturing number, etc.) brings up a the item and/or catalog page(s) for the source vendor and the item and/or catalog page(s) of the competitors where the match took place, providing reference to the searched product.

With reference to the figures, and more particularly, with reference to FIG. 1, the following discloses various example systems and methods for providing third party cross referencing on a computer network, such as a personal computer or mobile device. To this end, a processing device 20″, illustrated in the exemplary form of a mobile communication device, a processing device 20′, illustrated in the exemplary form of a computer system, and a processing device 20 illustrated in schematic form, are provided with executable instructions to, for example, provide a means for a customer, e.g., a user, client, corporate shopper, buyer, consumer, etc., to access a host system server 68 and, among other things, be connected to a hosted vendor purchasing system, e.g., a website, mobile application, etc. Generally, the computer executable instructions reside in program modules which may include routines, programs, objects, components, data structures, etc. that perform particular tasks or implement particular abstract data types. Accordingly, those of ordinary skill in the art will appreciate that the processing devices 20, 20′, 20″ illustrated in FIG. 1 may be embodied in any device having the ability to execute instructions such as, by way of example, a personal computer, a mainframe computer, a personal-digital assistant (“PDA”), a cellular telephone, a mobile device, a tablet, an ereader, or the like. Furthermore, while described and illustrated in the context of a single processing device 20, 20′, 20″ those of ordinary skill in the art will also appreciate that the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the example processing device 20 includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer-readable instructions, data structures, program modules, and other data for the processing device 20. Those of ordinary skill in the art will further appreciate that other types of non-transitory computer-readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example via a network connection.

To allow a user to enter commands and information into the processing device 20, input devices such as a keyboard 54 and/or a pointing device 56 are provided. While not illustrated, other input devices may include a microphone, a joystick, a game pad, a scanner, a camera, touchpad, touch screen, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as, for example, speakers, cameras, printers, or other suitable device.

As noted, the processing device 20 may also utilize logical connections to one or more remote processing devices, such as the host system server 68 having associated data repository 68A. The example data repository 68A may include any suitable vendor data including, for example, customer/company information, electronic catalog pages, inventor, etc. In this example, the data repository 68A includes a listing of a plurality of products that are available for purchase. Each of the products includes a vendor item number, and may include an associated secondary item number or description, such as a manufacturer's model number, a keyword description, barcode, etc. In addition, the example data repository 68A includes data specific to products offered by a third party vendor, such as catalog pages and/or descriptions related to competitor products. The stored third party data may be static (i.e., is fixedly stored in the data repository 68A) or may be dynamic (e.g., is periodically updated, is directed to a third party link, such as a URL link, etc.)

In this regard, while the host system server 68 has been illustrated in the exemplary form of a computer, it will be appreciated that the host system server 68 may, like processing device 20, be any type of device having processing capabilities. Again, it will be appreciated that the host system server 68 need not be implemented as a single device but may be implemented in a manner such that the tasks performed by the host system server 68 are distributed amongst a plurality of processing devices/databases located at different geographical locations and linked through a communication network. Additionally, the host system server 68 may have logical connections to other third party systems via a network 12, such as, for example, the Internet, LAN, MAN, WAN, cellular network, cloud network, enterprise network, virtual private network, wired and/or wireless network, or other suitable network, and via such connections, will be associated with data repositories that are associated with such other third party systems. Such third party systems may include, without limitation, systems of banking, credit, or other financial institutions, systems of third party providers of goods and/or services, systems of shipping/delivery companies, etc.

For performing tasks as needed, the host system server 68 may include many or all of the elements described above relative to the processing device 20. In addition, the host system server 68 would generally include executable instructions for, among other things, facilitating the ordering of a vendor product, facilitating a cross reference of inventory numbers, facilitating a comparison of third party inventory to vendor inventory, providing access to merchandise purchasing, etc.

Communications between the processing device 20 and the host system server 68 may be exchanged via a further processing device, such as a network router (not shown), that is responsible for network routing. Communications with the network router may be performed via a network interface component 73. Thus, within such a networked environment, e.g., the Internet, World Wide Web, LAN, cloud, or other like type of wired or wireless network, it will be appreciated that program modules depicted relative to the processing device 20, or portions thereof, may be stored in the non-transitory memory storage device(s) of the host system server 68.

As noted above, in the present example, a customer generally interacts with the host system server 68 to order/purchase goods of interest. To facilitate this process, the host system server 68 provides access to various product ordering input methods, including, for example, a single item input, a bulk ordering pad, and/or a list importation method that is made conveniently accessible on a page, such as a mobile application page, webpage, etc. displayed on the client computing device. More particularly, as illustrated in an example page, i.e. a webpage 200 of FIGS. 2-4, the host system server 68 provides in direct association with an inventory maintained in the data repository 68A, an access point 202 presented in the form of a user interface (graphical user interface, web-based user interface, touchscreen user interface, etc), such as at least one text box, by which the customer may enter an item identifying number.

In the illustrated example of FIGS. 2-4, the access point 202 comprises a text box to accept an order item number 202b, such as a vendor and/or non-vender SKU, manufacturing number, etc. The access point 202 provides an entry method by which a customer may input order information, including an item number, to conveniently search for, look-up, and/or purchase goods from the vendor. It will be appreciated that the form, location, etc., of the access point 202 may be displayed and/or vary as desired by design, and/or by display type (e.g., mobile device, personal computer, tablet, etc.). Still further, the type and/or manner of inputting the order information may be any suitable entry method including text, voice, picture, embedded macro, third party application data, scanner, motion, etc.

In the present example, a customer enters any suitable item number known to the customer in the corresponding access point 202 to initiate a search and/or purchase process. For instance, referring to the example of FIG. 2, there is illustrated an example of a customer entering an item number such as item number “5LE23” into the access point 202. By entering the item number information into the access point 202, the system host server 68 causes a look-up of the item number in the data repository 68A. It will be appreciated that the triggering event to perform the look-up of the item number in the data repository 68A may be caused by any suitable action, including for example, a change in the user interface focus, an activation of the access point by being clicked on, moused over, touched, and/or otherwise selected, a time delay, a real-time look-up, near real-time look-up, and/or any other suitable event trigger.

Upon the server 68 performing an item number look-up in the data repository 68A, the server 68 returns all matched and/or closely related search results to the window 200. More particularly, in this example, the returned information from the data repository 68A includes the detailed information regarding the vendor product, the vendor catalog page, a catalog page from at least one third party, functional equivalents, direct product matches from various third-parties, etc.

For instance, in the example of FIG. 2, the server 68 performs a look-up on the item code “5LE23” and returns a direct item match on the vendor item number “5LE23”, an alkaline “AA” battery. While performing the item look-up, the server 68 also performed a cross-reference look-up on the item as related to previously determined and/or selected third party products to return third party identified content. In one example, as noted above, the cross-reference look-up may return a previously stored third party catalog page, dynamically retrieved and/or linked third party catalog page(s), related products and their respective descriptions and/or related catalog page(s), specific third party items, etc.

As previously described, in the instance where the inputted item number corresponds directly to a vendor item number in the vendor catalog, the entered item number may simply return the vendor item without displaying any third party content as is known in the art.

Referring to the example of FIG. 2, a search on the item number “5LE23” as entered into the access point 202 will cause the system 68 to causes the window 200 to display the returned results to the customer in various user interface elements such as dialog boxes, in the form of a frame windows, or any other suitable user interface element display. In this instance, a frame 204 displays vendor product information directly related to the searched item number, such as in this instance, detailed product information for the identified Alkaline “AA” size battery.

Along with the frame 204, a plurality of tabs 206, 208, 210, may be presented to change the content of the frame 204 as is well known to one of ordinary skill in the art. In this example, the tabs 206, 208, 210, correspond to detailed information regarding the source vendor item, a first third party item, and a second third party item, respectively. Selection of any of the tabs 206, 208, 210, will change the displayed information in the frame 204 as desired.

In addition to the frame 204, which provides static and/or dynamically retrieved information regarding the target product entered into the access point 202, entering the search term will also cause the system 68 to display the returned results of any suitable contextual information, such as for example a catalog page, a category listing, or any other suitable contextual information, in the frames 212, 214, 216, and 218. In the present examples, each of the frames 212, 214, 216, 218, displays contextual information such as a catalog page from the respective vendor. In this example, the frame 212 includes a catalog page from the source vendor, and as such, the catalog page will typically reside within the data repository 68A itself. Each of the frames 214, 216, however, is populated, in this example, with a catalog page of a third party. The third party catalog page may be stored within the data repository 68A, or may alternatively be retrieved from the electronic catalog of a third party by any suitable retrieval method. For example, the third party data may be retrieved as disclosed by the systems and methods in U.S. Pat. No. 7,546,289, herein incorporated by reference in its entirety. The example frame 218, meanwhile includes a sample catalog page detail, which may include a highlighted product 218a to make contextual identification easier.

As illustrated in FIG. 3, selection and/or activation of one of the frames 212, 214, 216, 218, may cause the selected frame to expand, and/or otherwise provide additional information and/or views into the catalog page as desired. In the illustrated example, selection of the frame 212 causes the frame 212 to expand, covering a substantial part of the window 200. As will be appreciated to one of ordinary skill in the art, the frame 212 may be “closed” and/or otherwise deselected/deactivated, such that the frame restore to its previous location and/or size. Similarly, as illustrated in FIG. 4, selection of any of the tabs 206, 208, 210, and in this instance, selection of the tab 208, cause the detailed information in the frame 204 to change to the detailed information identified by the selected tab. In this manner, information regarding the source vendor item may be presented alongside information related to third party vendor products for comparison purposes.

It will be appreciated by one of ordinary skill in the art that while the present example frames and tabs include a finite number of each, the number, location, placement, etc. of each of the elements in the window 200 may vary as desired, such as for example dependent upon the type of device 20 the page 200 is displayed on, and/or may vary in response to other conditions, such as the number and/or type of returned searched results. Still further, while the current examples are illustrated as being directed to catalog pages, with specifically tabbed detailed information, it will be understood that the information may be presented in any suitable display format including a listing of items, a grid, a comparison matrix, etc.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A non-transient, computer readable media having stored thereon instructions for providing access to an automated third party cross referencing functionality related to an electronic vendor system, the instructions performing steps comprising:
storing in a data repository a listing of a plurality of products that are available for purchase, wherein each of the plurality of products is directly associated with a vendor item number;
causing a page to be displayed on a client computing device, the page comprising an access point in which an item number corresponding to a desired item is enterable to specify a query term;
receiving the query term at a server;
using the received query term to search the data repository to cross reference the entered item number with the vendor item number, wherein if the received query item does not match any vendor item number, using the received query term to search a database associated with a third party, parsing the results obtained by searching the database associated with the third party, and returning at least one of a product, category, or catalog page associated with the search results; and
causing a plurality of user interface elements, to be presented on the client computing device, each of the user interface elements displaying at least one of the product associated with the matched vendor item number or the returned product, category, or catalog page associated with the third party.

2. A computer-readable media as recited in claim 1, wherein the access point is a text box.

3. A computer-readable media as recited in claim 2, wherein the text box is a parseable text box adapted to allow for input of a plurality of item numbers.

4. A computer-readable media as recited in claim 1, wherein the entering the order number comprises at least one of text input, visual search, voice response, barcode reading, or scanning.

5. A computer-readable media as recited in claim 1, wherein selection of the one of the user interface elements comprises at least one of an input device selection, a client computing device tap, a client computing device movement, or a client computing device touch.

6. A computer-readable media as recited in claim 1, wherein the database associated with the third party includes information integrated with the data repository.

7. A computer-readable media as recited in claim 1, wherein the database associated with the third party includes a database associated with a remote server.

8. A computer-readable media as recited in claim 1, wherein each of the user interface elements comprises a link selectable to invoke a further user interface to provide additional information regarding the relevant product corresponding to the user interface element.

9. A computer-readable media as recited in claim 8, wherein the additional information is a catalog page from a catalog on which resides the relevant product.

10. A computer-readable media as recited in claim 9, wherein catalog page includes a highlighted section corresponding to the item number.

11. A computer-readable media as recited in claim 8, wherein selection of the link causes the vendor system to redirect to a further page.

12. A computer-readable media as recited in claim 11, wherein the further page is located within the vendor system.

13. A computer-readable media as recited in claim 11, wherein the further page is located within a remote system of a third party.

13. A computer-readable media as recited in claim 1, wherein the user interface elements are presented in a pop-up window within the client computing device.

14. A computer-readable media as recited in claim 1, wherein the user interface elements are presented in a portion of the displayed page.

15. A computer-readable media as recited in claim 1, wherein each of the plurality of products is directly associated with a vendor item number and wherein each of the plurality of products is capable of being associated with at least one of a secondary item number;
in response to an entering of the item number in the order access point causing the vendor system to query the data repository to cross reference the entered item number with the vendor item number and to query the data repository to cross reference the entered item number with at least one of the secondary item number or the description of each of the plurality of products, and obtain a subset of relevant products associated with the entered item number when the entered item number does not correspond to a specific vendor item number stored in the data repository; and
wherein causing the plurality of user interface elements, to be presented on the client computing device, further comprises causing at least one of user interface elements to display at least one of the subset of relevant products associated with item number.
